(19) United States
(12) Patent Application Publication
(10) Pub. No.: US 2025/0033316 A1
(43) Pub. Date: Jan. 30, 2025

(54) MULTILAYERED HOLLOW BODY MADE OF A TEXTILE COMPOSITE

(71) Applicant: Paul REICHARTZ, Korschenbroich (DE)

(72) Inventor: Paul REICHARTZ, Korschenbroich (DE)

(21) Appl. No.: 18/915,117

(22) Filed: Oct. 14, 2024

Related U.S. Application Data
(63) Continuation of application No. PCT/EP2023/059814, filed on Apr. 14, 2023.

(30) Foreign Application Priority Data
Apr. 14, 2022 (DE) 10 2022 109 350.6

(51) Int. Cl. B32B 1/08; B32B 5/02; B32B 5/06; B32B 9/04

(52) U.S. Cl. CPC B32B 1/08; B32B 5/022; B32B 5/06; B32B 9/042; B32B 2250/42; B32B 2307/7376

(57) ABSTRACT

The invention relates to a hollow body, in particular for a pole, pillar or tube, comprising at least one hollow profile-shaped main body with at least two adjacent layers, at least one of which is a textile layer comprising natural fibers selected from the group of bast fibers, leaf fibers or fruit fibers, at least one of the layers being impregnated with a matrix material, characterized in that at least the textile layer comprises a sheet-like textile structure, in particular a woven fabric, weft-knitted fabric, warp-knitted fabric and/or felt, and a method for its manufacture.

### RELATED APPLICATIONS

This application is a continuation of PCT/EP2023/059814, filed on Apr. 14 2023 the content of which is hereby incorporated by reference in its entirety. PCT/EP2023/059814 claims priority to German application DE 10 2022 109 350.6 filed on Apr. 14 2022.

### BACKGROUND OF THE INVENTION

The present invention relates to a hollow body, in particular for a pole, pillar or tube, comprising at least one hollow profile-shaped main body with at least two adjacent layers, of which at least one is a textile layer comprising natural fibers selected from the group of bast fibers, leaf fibers or fruit fibers, at least one of the layers being impregnated with a matrix material. The invention also relates to a method of manufacturing such a main body.

Materials such as steel, concrete or reinforced concrete are often used for the construction of overhead line pylons, such as pylons for the high-voltage or medium-voltage grid. However, the production of solid or hollow section components made of steel and/or concrete is associated with high energy consumption. The dismantling and recycling of such components and the associated disposal of the materials can also be relatively costly and harmful to the environment.

Wood can be a more environmentally friendly alternative material. However, the use of wood is disadvantageous in view of the increasing global demand. Wooden poles are also comparatively limited in their load-bearing capacity. Furthermore, environmentally harmful impregnating agents are regularly used to protect wooden poles from negative environmental influences.

US 2008/0274319 A1 discloses a multilayer hollow body made of a composite material that can be produced using a fiber winding process and can be used as a pole or tube, for example. The hollow body has an inner core and one or more layers wound around the core, the core and the layers being formed from a polyurethane resin and a reinforcement impregnated with the resin. The reinforcement may, for example, comprise fibers, particles, flakes or fillers made of glass, carbon or aramid as well as plant-based materials such as jute or sisal.

WO 2020/160603 A1 discloses a multilayer material that can be used to produce a hollow profile-shaped body in a winding process. The material has a base layer of paper, cardboard or a solid polymer of a natural, in particular vegetable, material and a layer of a flowing, liquid or molten natural polymer applied thereon, which combines with the base layer and hardens. In one disclosed embodiment, the multilayer material may comprise, for example, an outer and an inner layer of a natural material, a base layer of paper or cardboard and a woven layer, wherein the woven layer may comprise, inter alia, jute, hemp or sisal fibers. In addition, a layer of a liquid, natural polymer can be arranged between the woven layer and the base layer, which bonds with the other layers and causes the material or the hollow profile-shaped body to harden and solidify.

### SUMMARY OF THE INVENTION

The object of the present invention is to provide a hollow body of the type mentioned above, which has a high strength, is lightweight and environmentally compatible and is suitable for various uses.

This object is met by a hollow body according to claim 1 in that at least the textile layer comprises a sheet-like textile structure, in particular a woven fabric, weft-knitted fabric, warp-knitted fabric and/or felt. Preferred embodiments of the hollow body according to the invention result from the features of the subclaims.

### BRIEF DESCRIPTION OF THE FIGURES

Possible embodiments of the hollow body are explained in more detail below with the aid of figures. The figures show:

FIG. 1a: the layered structure of a first embodiment of a hollow body according to the invention;

FIG. 1b: a cross-section of the hollow body of the first embodiment;

FIG. 2a: the layered structure of a second embodiment of a hollow body according to the invention;

FIG. 2b: a cross-section of the hollow body of the second embodiment;

FIG. 3a: the layered structure of a third embodiment of a hollow body according to the invention;

FIG. 3b: a cross-section of the hollow body of the third embodiment;

FIG. 4a: the layered structure of a fourth embodiment of a hollow body according to the invention;

FIG. 4b: a cross-section of the hollow body of the fourth embodiment;

FIG. 5a: the layered structure of a fifth embodiment of a hollow body according to the invention;

FIG. 5b: a cross-section of the hollow body of the fifth embodiment.

### DETAILED DESCRIPTION

A layer is defined by the fact that it can be produced with one or more components, in particular material webs, whereby the several components are then already present in the composition in which they are used for the production of the layer before the layer is formed.

The main body comprises at least one textile layer which has a flat textile structure.

The textile layer comprises natural fibers. Natural fibers are usually differentiated according to their origin and can be of plant or animal origin. According to the invention, bast fibers, leaf fibers or fruit fibers, i.e. comparatively thick natural fibers of plant origin, are used. They are characterized by a high natural stiffness, whereby they promote the strength of the hollow body. These natural fibers are also good at absorbing liquids such as a liquid matrix material or a dye, which can be used to influence the properties of the main body. The seed fibers, such as cotton fibers, which are also basically natural fibers of plant origin, are not if significance for the hollow body according to the invention and are only comprised in the textile layer in subordinate quantities, if at all.

According to the invention, the textile layer comprises a flat textile structure made of fibers or threads produced therefrom, which are preferably formed into a flat textile structure by crossing or interlacing or looping. The flat textile structure is able to absorb forces very well both in the longitudinal direction of the main body and transversely to it. This means that the textile layer primarily acts as a reinforcement and therefore has a significant influence on the strength properties of the hollow body.

Impregnating at least one of the layers with a matrix material helps to improve the transfer of forces between the layers. For, the matrix material creates a material bond between the adjacent layers. The matrix material creates a material bond between the interior of at least one of the adjacent layers and the surface of the adjacent layer. The impregnation, i.e. the soaking of at least one of the layers with the matrix material, means that loads can be transferred comparatively well from one layer to the adjacent layer, in contrast to adhesive bonding, in which only the surfaces of the layers are bonded together. Of course, it is advantageous if not just one of the layers, but both adjacent layers are impregnated with the matrix material, so that the matrix material completely bonds the fibers of both adjacent layers together, resulting in an even deeper connection between the adjacent layers. At the same time, one layer can be stiffened by impregnation with the matrix material, thereby increasing its strength.

In addition, the matrix material provides protection for both the impregnated layer and the surface of the adjacent layer against external environmental influences.

As a result, the hollow body according to the invention with at least one hollow profile-shaped main body, which has a multilayer structure in the sense of a composite material, has a low dead weight and a high strength both in the longitudinal direction and in the transverse direction. The hollow body according to the invention also has good elasticity properties. Thus, a basic body with the layered structure according to the invention with a modulus of elasticity of 10,000 N/mm² or more can easily be realized.

The multi-layer structure makes it possible to produce hollow bodies whose strength, elasticity, weight and size are adapted to a required specification profile by selecting and combining individual layers appropriately. The hollow body can also consist of several, possibly different main bodies, whereby the main bodies can be connected to each other, for example, in the longitudinal direction or transversely to each other.

In a particularly preferred embodiment of the invention, the textile structure is a woven fabric. A woven fabric has at least two thread systems arranged essentially perpendicular to one another, as a result of which it can be subjected to high tensile forces acting in the direction of at least one of the thread systems. The use of woven fabric contributes significantly to the strength of the hollow body.

Furthermore, the textile structure can also, but not exclusively, be a weft-knitted fabric, a warp-knitted fabric and/or felt. The felt can, for example, comprise or be formed from a woven, weft-knitted or warp-knitted structure.

Where appropriate, the individual layers can be made of different materials. For example, a layer may comprise one or more metal reinforcements that are incorporated into the textile structure, inserted into it or placed on top of it.

The hollow bodies according to the invention are particularly suitable for the construction of overhead line masts, lamp posts or wind turbine masts. Use as a chimney or pillar of a load-bearing structure of a building is also conceivable. Use as a pipe for fluids media of different pressure levels is also possible, whereby the main body of the hollow body can, for example, have an inner protective layer which seals an interior of the main body to the outside in order to prevent a fluid medium from escaping to the outside or to protect the fluid medium from an undesirable external influence.

The hollow body according to the invention is comparatively low-energy and uncomplicated to manufacture due to the multi-layer structure of the main body, while it has low material costs and a high level of environmental compatibility due to the use of natural raw materials. Furthermore, the hollow body is much easier and cheaper to transport than comparable components made of steel, concrete or wood due to its low weight. Not only is the transportation effort significantly lower due to the weight advantage, but the need for a crane to load and unload a transport vehicle and to erect masts or pillars from the hollow body according to the invention can also be dispensed with.

Preferably, the main body has at least one supporting layer. Among other things, the supporting layer serves to transmit the forces acting on the main body evenly within the main body to adjacent layers. In particular, the supporting layer can be designed such that it has a large contact surface with at least one adjacent layer whose fibers or threads are comparatively thick or coarse. This is particularly advantageous if the supporting layer is arranged between two textile layers. If the textile layers were directly adjacent to each other, they would only have a comparatively small contact surface with each other due to the interlacing or crossing of the filaments of the textile structure, as a result of which lower forces could be transmitted between them. However, if the contact surface is maximized by a supporting layer for each of these two layers, significantly higher forces can be transmitted between the layers, so that higher shear forces can be transferred in the main body. But even if the supporting layer is only adjacent to one textile layer, it ensures a more even distribution of forces within the textile layer.

In a preferred embodiment of the hollow body according to the invention, the main body has at least two textile layers and at least one supporting layer for increased strength, with at least one supporting layer being arranged between two adjacent textile layers to improve the force transmission between the layers. For particularly high strength, the main body can in particular have at least three textile layers and at least two supporting layers. Of course, the main body can also comprise a higher number of textile layers and supporting layers. Preferably, the main body comprises exactly three textile layers and two supporting layers, with one supporting layer being arranged between each two textile layers, for example when the aim is to provide a hollow body with the load-bearing capacity of a wooden mast for medium-voltage or telecommunications networks.

If the main body has two or more textile layers, it is possible that only one of these textile layers comprises a flat textile structure and other textile layers are formed by wound filaments, for example. However, in order to further increase the strength of the hollow body, at least two textile layers or preferably all textile layers can also comprise a flat textile structure. All textile layers can have the same textile structure. The textile structure can also be formed at least partially differently in at least one textile layer.

Furthermore, it is preferred if at least one and preferably all supporting layers comprise a flat textile structure. All supporting layers can have the same textile structure. The textile structure can also be at least partially different in at least one further layer. The textile structure of one or more supporting layers can also be the same or different to the textile structure of a textile layer. The textile structure of the supporting layer(s) is particularly preferably a nonwoven. Less preferred, but equally possible, is the use of paper or cardboard for a supporting layer. It is advantageous for the formation of a large contact surface with at least one adjacent layer if the surface of the textile structure of the additional layer is essentially closed, i.e. largely free of meshes or holes.

Preferably, the main body of the hollow body is at least partially formed from wound layers. At least one of the textile layers and/or the supporting layers can be wound, and particularly preferably all textile layers and/or all supporting layers are wound. The use of a known and proven manufacturing process such as a winding process ensures that the hollow body can be manufactured with high precision and reproducibility. It is also possible to automate the winding process as far as possible, which means that the hollow body can be produced cost-effectively, with consistent quality and a high level of error tolerance.

Furthermore, it is preferred if at least one outer textile layer is impregnated with a matrix material so that the hollow body is protected against harmful environmental influences. An outer textile layer is a textile layer that is arranged closest to an outer surface of the main body or forms the outer surface. Preferably, the outer and an inner one of the textile layers and, moreover, preferably all textile layers are impregnated with a matrix material. An inner textile layer is a textile layer that is arranged closest to an inner space of the main body or forms a surface facing the inner space. Furthermore, it is preferred if at least one of the textile layers and at least one supporting layer adjacent thereto, preferably all layers, are impregnated with a matrix material and these layers are connected to one another via the matrix material. Accordingly, it is also preferred that one of the supporting layers and preferably all of the supporting layers are impregnated with a matrix material. Impregnation of all layers ensures that they are firmly bonded and that the hollow body has a high strength and an essentially homogeneous stress distribution as well as good elasticity properties along its entire length and cross-section.

For use in a textile layer, jute fibers, kenaf fibers, hemp fibers and flax fibers are particularly suitable as bast fibers, sisal fibers and abaca fibers are particularly suitable as leaf fibers, and coconut fibers are particularly suitable as fruit fibers. These natural fibers are generally environmentally friendly and available in large quantities. A textile layer may comprise either exclusively fibers of one of the aforementioned fiber types or a combination of several of the aforementioned fiber types. For example, when using a fabric, the weft and warp yarns can each consist of a different type of fiber. One of the advantages of the aforementioned fiber types is that they are very easy to impregnate. A main body made of solid wood, on the other hand, can only absorb a matrix material comparatively superficially and in small quantities and therefore has less protection against environmental influences and a shorter durability.

Sisal fibers are particularly preferred. Sisal fibers have the advantage that they comprise a high proportion of cellulose, lignin and pectin, among other things, and therefore have a high tensile strength and stiffness. Sisal fibers are also naturally resistant to weathering. Sisal fibers are also highly resistant to microorganisms, which can have a damaging effect on the hollow body, particularly if it comes into at least partial contact with the ground. Sisal fibers are also inexpensive to procure.

In order to further improve the environmental compatibility of the hollow body according to the invention, at least one and preferably all of the supporting layers can comprise at least natural fibers, but also synthetic fibers such as polyester fibers. The mass ratio of natural fibers to synthetic fibers can preferably be in a range from 2 to 1 to 1 to 2, particularly preferably 1 to 1.

It is advantageous if at least one of the supporting layers has at least one carrier material and at least one wooden layer, which can increase the strength of the hollow body. The carrier material and the wooden layer should preferably be bonded together before the main body is manufactured in order to prevent the wooden layer from breaking during bending or winding. The wooden layer preferably has a thickness of at least 0.4 mm and at most 1.2 mm, in particular at least 0.6 mm and at most 1.0 mm or particularly preferably at least 0.7 mm and at most 0.9 mm. The wooden layer can in particular be a veneer and the carrier material can in particular be a non-woven. Furthermore, supporting layers with two, three or more wooden layers are also possible, for example.

The matrix material of the hollow body can preferably comprise a resin, in particular a phenolic resin, but also water glass or a comparable material. For improved environmental compatibility, the phenolic resin can optionally comprise proportions of a natural polymer such as lignin or be based entirely on a natural polymer. In addition to ensuring that the hollow body has appropriate strength properties, impregnation with an appropriate matrix material also ensures, in particular, that the hollow body is resistant to microorganisms such as fungi, which can cause wood rot such as white rot or brown rot, particularly in the soil, and to moisture. This means that the hollow body can easily be used as a pole or pillar or as a component thereof in soils. Furthermore, the hollow body can be exposed to low and high temperatures, for example in a range from-30 to 100° C. The hollow body is also largely UV-resistant due to the matrix material and can therefore be exposed to direct sunlight over a period of several years or decades without damage.

Depending on the use of the hollow body, the main body can, for example, have a circular, oval, rectangular or polygonal cross-section. Irrespective of the shape of the cross-section, the main body can also have a constant cross-section over its entire length or a variable cross-section, for example a cross-section that is at least partially tapered towards at least one of its ends.

In order to improve the transmission of force between individual layers, in a further preferred embodiment of the hollow body, the main body has at least one connecting means which is suitable for engaging in at least one textile layer and/or supporting layer, so that at least two layers are directly or indirectly coupled to one another by the connecting means. Suitable connecting means can completely take over the function of a supporting layer and can therefore be used as an alternative.

Preferably, the connecting means is a metal strip, in particular a metal mesh strip, which is arranged in sections between two layers in the longitudinal direction of the main body. In particular, the metal strip has at least one, but preferably a plurality of hook-like elements, whereby these can, for example, protrude alternately at certain distances from one or each of the two sides of the metal strip and in this way can engage in a material structure of a layer adjacent to one of the two sides of the metal strip. Such a metal strip can absorb shear forces occurring between the layers in particular. Additionally or alternatively, the connecting means can also be incorporated into the flat textile structure of a textile layer and/or supporting layer.

Also staples can be provided as connecting means for connecting two or more layers. Connecting two or more layers with staples is not only useful to support the layers against each other, but also to ensure in a manufacturing process that the layers fit closely together when a matrix material hardens. The elastic properties and strength of the hollow body can be influenced by the choice of staple type and the distribution of the staples over the hollow body in the circumferential and longitudinal direction and, if necessary, also in their position in different planes of the layer composite. Staples can also be distributed in different planes of the layer composite. For example, so-called greenhouse staples and, in particular, multi-legged staples such as three- or four-legged staples with round or polygonal shapes are suitable for creating a very strong press fit between the layers to be joined.

Depending on the use of the hollow body, it can be useful if the main body has a decorative layer as the outermost layer, which primarily serves to visually enhance the hollow body. A decorative layer can be advantageous in particular, but not exclusively, if the hollow body is used as a pole, for example, and is installed at least partially above the ground. In addition, the decorative layer can also be designed to protect the hollow body from harmful environmental influences, for example. For example, the decorative layer can be formed from a paint or a foil. During the production of the hollow body, the decorative layer can also prevent liquid matrix material from escaping from the hollow body to the outside before it cures.

It is possible that the hollow body is exposed to different levels of stress in different sections. It can therefore be useful if the main body has at least one additional textile and/or supporting layer in at least one section along its longitudinal direction. In this way, the strength of the main body can be increased in sections in order to absorb different levels of force at different points. For example, when used as a mast or pillar, the hollow body can be fixed at a lower end in the ground or a foundation, whereby higher forces can occur in this section than in other sections of the hollow body. It is also possible that higher forces occur at an upper end of the mast if other elements such as a crossbeam are attached there. By arranging additional layers only in sections, costs and weight can be saved compared to arranging such layers along the entire hollow body.

It can also be advantageous if the hollow body has at least one transponder that is set up to receive and transmit data. Preferably, the transponder does not require an external power supply. For example, the transponder can be set up to store data about the respective hollow body, such as the date of manufacture, a serial number or the material composition, so that these can be read out in the immediate vicinity during transportation or when a hollow body is installed, or can be transmitted over a greater distance. Additionally or alternatively, the hollow body can have sensors and a storage unit for sensor data so that, for example, historical data on ambient temperature, humidity or dynamic loads can be stored so that the data can be used to make a statement that or when the hollow body requires maintenance due to wear or should be replaced.

In order to protect the hollow body from infestation by pests, in particular termites, the main body can be provided with a biocide as part of one or all layers, between two or more layers or as an outermost layer.

A main body for a hollow body according to the invention can preferably be produced by a method according to claim 22.

For example, known spiral winding machines can be used to carry out the process, with which, among other things, tubular paper or cardboard tubes are usually produced. For this purpose, webs of material are continuously wound in a spiral around the longitudinal axis of a winding mandrel, for example a stationary mandrel, to form one or more layers, whereby the wound, formed layers rotate around the longitudinal axis of the winding mandrel by means of a drive such as a belt drive and can be moved along this axis. As a result of the rotation, the material webs provided are unwound from corresponding devices and continuously wound around the longitudinal axis of the winding mandrel, creating a hollow body in an endless process. Spiral winding processes are also known in which components are wound individually and not endlessly.

To produce a hollow profile-shaped, multi-layered main body using the method according to the invention, webs of material are wound spirally and at a constant angle around a longitudinal axis of a winding mandrel so that they form a layer. The material webs are wound in the order in which the layers of the main body are to be formed from the inside to the outside, with the at least one material web of the innermost layer being wound first. The material web does not have to be wound directly onto the winding mandrel, but can, for example, be wound onto a mold or foil surrounding the winding mandrel.

For the manufacture of the hollow body, it is crucial that the at least one material web of a subsequent layer is not wound until the previous, adjacent layer has already been formed in the area in which the material web of the subsequent layer is wound around the longitudinal axis of the winding mandrel. This means that the material web of the previous layer must have been wound at least partially around the longitudinal axis of the winding mandrel in this area, depending on its width and the width of the material web of the subsequent layer, before the material web of the subsequent layer is wound. Such a method can be used to form a large number of different layers for a main body. It is also possible with the method according to the invention to change the size of the main body cross-section according to the use of the hollow body.

In order for the main body to develop the required strength properties, a matrix material is introduced into at least one web of material, which is designed to cure after the main body has been wound and to bond all layers together. The material web can, for example, be pre-impregnated in a process upstream of the method and already provided, and it can be wound with partially cured matrix material as so-called prepreg. In this case, the matrix material, which is not yet cured, can be liquefied before curing. Care must be taken to ensure that the prepreg only comprises sufficient matrix material to allow it to be wound around the longitudinal axis of the winding mandrel without damage. Alternatively or additionally, it is possible for at least one layer to be impregnated with a matrix material after only this or all layers of the main body have been wound, for example by introducing the matrix material into the layers under pressure (e.g. boiler pressure impregnation). It is also conceivable that one or all of the layers are impregnated in an immersion process.

In order to increase the efficiency of the process, it is advantageous if one or more of the material webs for the textile layers are provided as prepregs. In particular, if not all of the material webs are provided as prepregs, it is advantageous if the prepregs are supersaturated with matrix material. In a process step after the winding of all material webs, the matrix material in the prepregs that has not yet hardened is then liquefied so that it can diffuse from the prepreg layer(s) into neighboring layers whose material webs were not provided as prepregs, so that as a result the entire main body is impregnated with the matrix material. For a large number of applications, it will be necessary or at least sensible for all layers to be impregnated with the matrix material at the end of the process and for the matrix material to have cured. Depending on the requirement profile, however, it may be sufficient if only some of the layers, for example the innermost and/or the outermost layer, comprise a cured matrix material.

To further increase process efficiency, it is useful if the material web of a subsequent layer is wound essentially at the same time and in the same area as the material web of a previous layer. This means that the material web of a subsequent layer is wound immediately when the previous material web is sufficiently formed in the corresponding common area. An insignificant time delay in the winding of the material webs occurs at most when the winding machine starts up, when no material web has yet been wound. Preferably, all material webs are wound simultaneously in the same area. For this purpose, the material webs can be wound at least partially on top of each other at the same time.

Preferably, the material web of a layer is wound parallel to the joint. This means that the edges of one winding are wound parallel to the edges of the adjacent winding so that a continuous joint is formed in one layer. In principle, it is advantageous to wind a material web in such a way that the width of the joint is minimal. For the strength of the hollow body, it is advantageous if the material web of a subsequent adjacent layer is wound in such a way that it covers the joint formed in the previous layer. In particular, the material web can be aligned centrally to the joint so that it covers the joint evenly on both sides.

In order to ensure the required strength of the hollow body, at least one material web can be wound around the longitudinal axis of the winding mandrel under tensile stress, whereby a certain pressure is built up within the main body, which influences the strength of the solidified hollow body. The tensile stress with which the material webs are wound can vary from web to web.

To prevent the material webs of the layers from separating from each other again independently, at least one connecting means can be provided on at least one material web or between a previous layer and a subsequent layer, which is suitable for coupling the formed layers to each other in the sense of pre-strengthening before the matrix material hardens. It is essential that the connecting means is suitable for connecting the layers to each other in such a way that a pressure formed in the main body is maintained for a certain period of time, for example until the matrix material has cured.

In particular, the connecting means can be an adhesive, for example a so-called hot-melt adhesive, which is applied at least partially to the material web of a subsequent layer before winding, thereby bonding it to the previous layer. The adhesive can be applied to the material web in a serpentine manner and at specific intervals.

As an alternative or in addition to this, a thread coated with an adhesive, for example a hot-melt adhesive, can be used as a connecting means, which is wound between two layers at certain intervals. Such a thread can also be incorporated into the textile structure of a layer. Before or immediately after winding, the thread's adhesive is heated, causing it to liquefy and then harden so that the adjacent layers adhere to each other. It is essential that the adhesive is suitable for bonding two layers immediately after winding so that they cannot separate from each other independently as soon as there is no longer any tensile stress on the material webs.

In yet another alternative, a metal strip, in particular a metal mesh strip, can be used as a connecting means, which is designed to absorb shear forces occurring between two layers and thus prevent the layers from separating automatically. For this purpose, the metal strip can be provided on one or both sides with barbs that engage in the adjacent layer. The metal band can also be designed to hold adjacent layers together during winding and also in the subsequent production process, so that the layers lie close together, particularly during the curing of the matrix material. To achieve this, clamps such as greenhouse staples and multi-legged clamps such as three- or four-legged clamps with round or polygonal shapes can also be used as an alternative or supplement.

In a further embodiment of the method according to the invention, it is also possible that the pressure built up in the main body by the tensile stress of the material webs during winding is ensured by a sheath layer. The sheath layer can in particular be a foil made of a synthetic polymer, for example a silicone-coated polyurethane foil, and/or a non-woven fabric, preferably a thread-reinforced non-woven fabric, which can be removed again as required after the matrix material has cured. The sheath layer can also be designed in such a way that it leaves a smooth outer surface of the hollow body after detachment from the main body. The coating layer can also have a protective function against possible damage during transportation or installation of the hollow body. In another embodiment, the sheath layer can also remain a permanent part of the main body and serve as a decorative or protective layer, for example.

To ensure that the at least one material web can be wound with a certain tensile stress, a counter-pressure body can preferably be formed from an innermost layer of the main body comprising paper or cardboard. The innermost layer can preferably be wound around the longitudinal axis of the winding mandrel before the other layers. In order to ensure the required strength of the counter-pressure body, it can, for example, consist of several layers, whereby the individual layers are bonded together by an adhesive. It is essential that the innermost layer formed from the counter-pressure body has such a high strength when the remaining material webs are wound under a certain tensile stress that it is not compressed by the applied tensile stress. The innermost layer of paper or cardboard also has the advantage that it can be detached from the winding mandrel easily and largely without leaving any residue and prevents the winding mandrel from sticking to one of the other material webs. Depending on how the hollow body is used, the counter-pressure body can remain in the main body as so-called lost formwork or be removed from it once the process is complete.

Alternatively, a counterpressure body can also be formed by a supporting layer with at least one wooden layer as the innermost layer.

Especially if the counter-pressure body remains in the hollow body as a lost formwork, but not only then, it can be useful to connect the first but also other wound layers to the counter-pressure body using connecting means such as the previously described clamps. This can serve to stabilize the shape of the main body during curing by ensuring that the wound layers not only lie against each other, but also against the shaping counter-pressure body. This can be advantageous not only when using pre-impregnated material webs (prepregs), but also when immersion impregnating the main body after all the material webs of the main body have been wound.

Particularly in the case of immersion or boiler pressure impregnation, the counter-pressure body also has the advantage that excess matrix material absorbed by the material webs can be pressed out of the main body again in a targeted manner, for example by rolling by means of several rollers arranged around the main body, between which the main body is rotated.

During the manufacture of the hollow body, gases can form in particular when the matrix material cures in the main body. To prevent the main body from being damaged by the gases, at least the material that forms the outermost and/or innermost layer of the main body can advantageously be open to diffusion in such a way that any gases produced can escape into the environment. For this purpose, for example, an inner paper or cardboard layer as lost formwork or a sheath layer that is not open to diffusion could be perforated. Care must be taken to ensure that liquid matrix material does not escape from the main body through the diffusion-open layer.

It is also preferable if the main body is wound in an endless process and cut to a specific, freely selectable length after the matrix material has cured.

The curing of the matrix material of the impregnated material webs takes place at a temperature suitable for the matrix material. For example, the main body is exposed to the appropriate temperature in a convection oven for the entire duration. Additionally or alternatively, curing can be carried out using UV light depending on the matrix material. Furthermore, a uniform distribution of the matrix material in the main body can be promoted by rotating the main body around its longitudinal axis during curing by means of a corresponding device, for example a so-called turret drum.

Possible embodiments of the hollow body are explained in more detail below with the aid of figures.

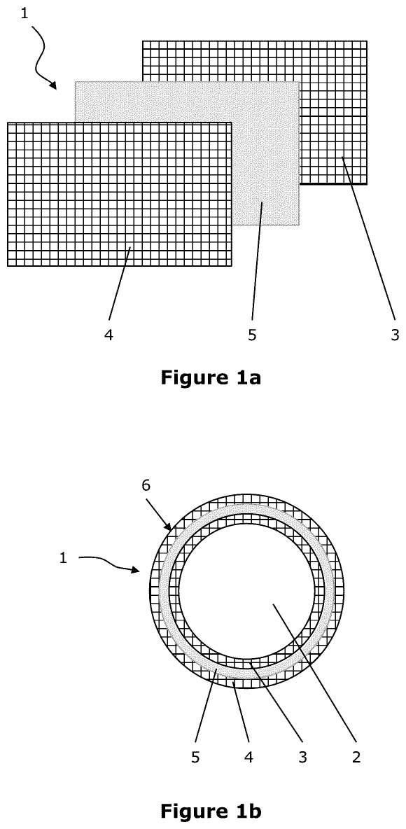

FIGS. 1a and 1b show a first embodiment of the hollow body 1 according to the invention, with FIG. 1a schematically showing the structure of the individual layers and FIG. 1b showing a section transverse to the longitudinal direction of the hollow body. The hollow body comprises exactly one main body 6 with a circular cross-section, which has an inner space 2 in the center, which is surrounded by several wound layers. The innermost layer of the hollow body is a first textile layer 3, which is a flat textile structure comprising a fabric. The outermost layer is a second textile layer 4, which also comprises a fabric. The fabric of the textile layers 3, 4 consists of sisal fibers and has a gross weight of, for example, 950 g/m² and a thickness of, for example, originally 2, 3 mm, although this can increase in an impregnated and cured layer. Between the first textile layer 3 and the second textile layer 4 is a supporting layer 5, which comprises a non-woven fabric with natural and synthetic fibers. All layers were each wound with one material web. In addition, the material webs of the layers are impregnated with a phenolic resin and bonded together in such a way that they form the bonded main body 6. The thickness of the individual layers and the ratio of the layer thicknesses to the diameter of the inner chamber 2 are only shown as examples and can be adapted as required. Such a hollow body 1 can be used as an electricity or telecommunications pole, for example.

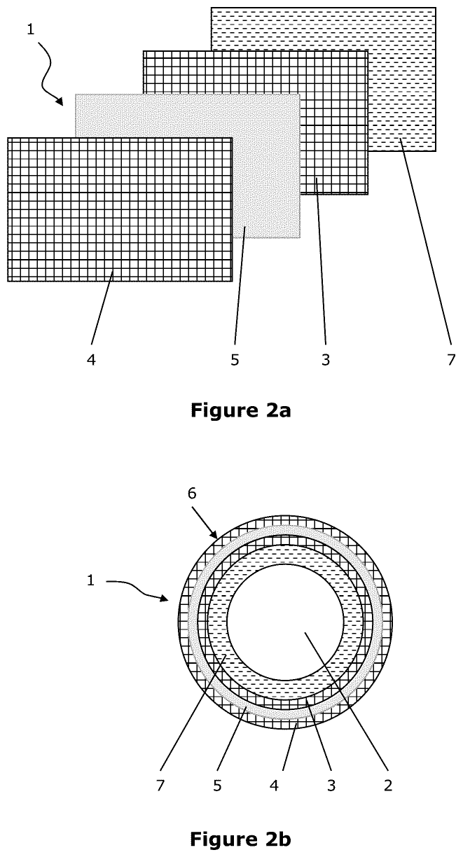

FIGS. 2a and 2b show a second embodiment of the hollow body 1 according to the invention, which differs from the first embodiment example in that the main body 6 has as its innermost layer a counter-pressure body 7 wound from cardboard, which has remained in the main body 6 after it has been manufactured.

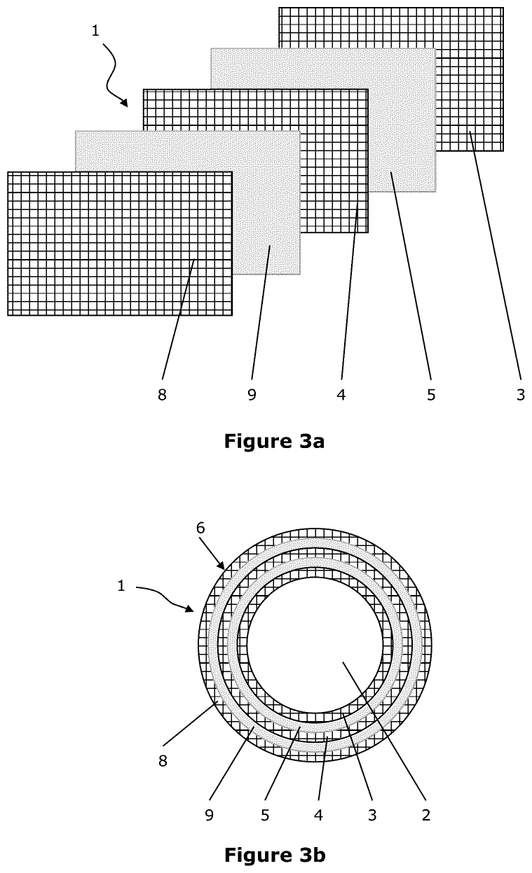

FIGS. 3a and 3b show a third embodiment of the hollow body 1 according to the invention, which differs from the first embodiment example in that the main body 6 has a third textile layer 8 with a woven fabric and a second supporting layer 9 with a non-woven fabric. In each case, one of the supporting layers 5, 9 is arranged between two textile layers 3, 4, 8. A hollow body 1 with such a layered structure has a higher strength than the hollow body 1 of the first embodiment example.

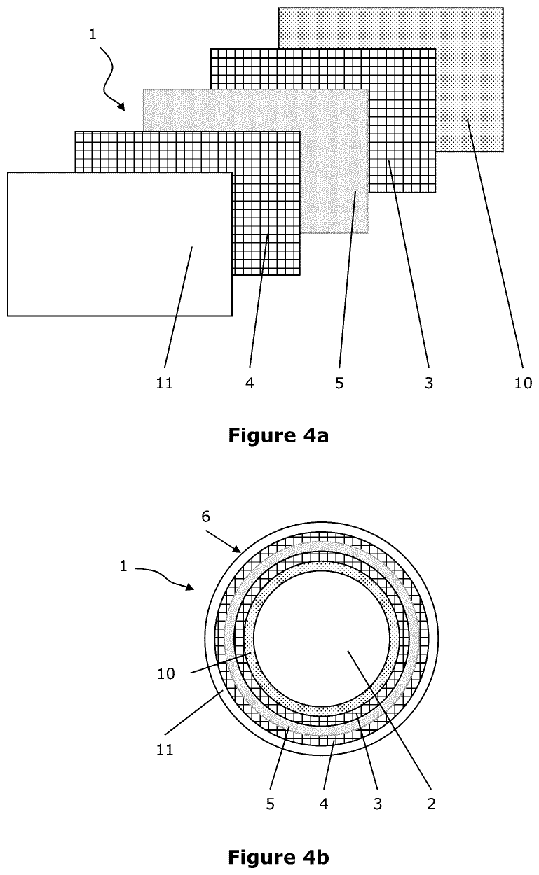

FIGS. 4a and 4b show a fourth embodiment of the hollow body 1 according to the invention, which differs from the first embodiment in that the main body 6 has a decorative layer 11 as the outermost layer, which is adjacent to the second textile layer 4. Furthermore, the innermost layer of the main body 6 has a protective layer 10 adjacent to the first textile layer 3, which is designed, among other things, to prevent a fluid medium from escaping from the interior 2. Such a hollow body can be used, for example, in civil engineering as a pipe for liquids or gases.

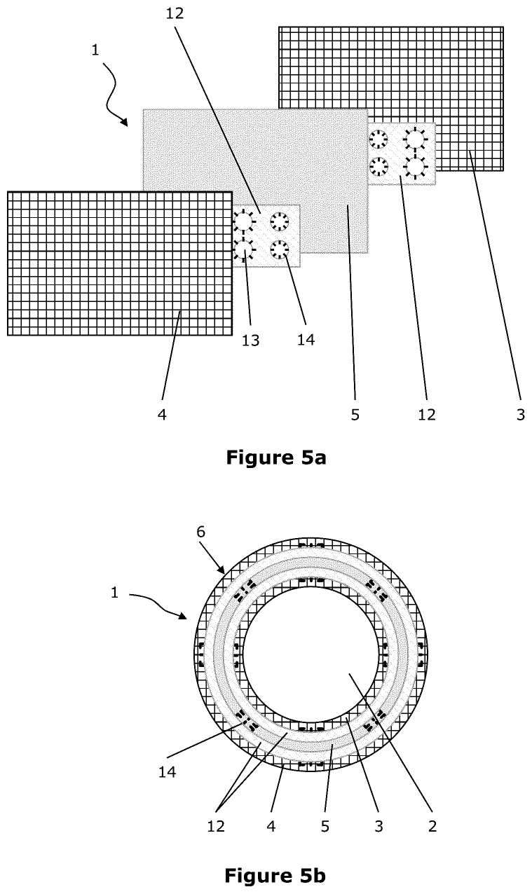

FIGS. 5a and 5b show a fifth embodiment of the hollow body 1 according to the invention, in which a metal fabric strip 12 is arranged between the first textile layer 3 and the supporting layer 5 and between the second textile layer 4 and the supporting layer 5. Two rows of holes 13 are punched into the metal fabric strip 12, at the edges of which several hook-like elements 14 protrude. In each case, two holes 13 arranged one above the other in FIG. 5a form a pair. The hook-like elements 14 of adjacent pairs protrude alternately on opposite sides of the metal mesh strip 12. The hook-like elements 14 engage the adjacent layers and serve to absorb shear forces between the layers of the main body 6 during manufacture before the matrix material cures, so that the tensile stress in the layers is essentially maintained. The metal mesh strip 12 does not have to extend completely along the length of the main body 6, but can only be inserted in sections, as indicated in FIG. 5a.

The hollow body according to the invention is not limited to the layer combinations shown in the embodiments but can have any other layer combinations and numbers of layers.

### REFERENCE NUMERALS

1 hollow body
2 interior
3 first textile layer
4 second textile layer
5 supporting layer
6 main body
7 counter pressure body
8 third textile layer
9 second supporting layer
10 protective layer
11 decorative layer
12 metal mesh strip
13 holes
14 hook-like elements

1. A hollow body comprising at least one hollow profile-shaped main body with at least two layers, of which at least one is a textile layer which comprises natural fibers selected from the group of bast fibers, leaf fibers and fruit fibers or a combination thereof, at least one of the layers being impregnated with a matrix material, and wherein at least the textile layer comprises a sheet-like textile structure.

2. The hollow body according to claim 1, wherein one of the at least two layers is a supporting layer adjacent to the textile layer.

3. The hollow body according to claim 2, wherein the main body comprises at least two textile layers and at least one supporting layer.

4. The hollow body according to claim 3, wherein the main body comprises at least three textile layers and at least two supporting layers, one supporting layer being arranged in each case between two textile layers.

5. The hollow body according to claim 3, wherein at least one of the textile layers comprises a fabric as a sheet-like textile structure.

6. The hollow body according to claim 2, wherein at least one supporting layer comprises a sheet-like textile structure.

7. The hollow body according to claim 1, wherein at least one of the textile layers and/or the supporting layers are wound.

8. The hollow body according to claim 1, wherein at least one outer one of the layers and/or at least one of the textile layers and at least one supporting layer adjacent thereto are impregnated with a matrix material.

9. The hollow body according to claim 1, wherein the natural fibers of at least one of the textile layers and preferably of all textile layers are selected from the group consisting of sisal fibers, jute fibers, coconut fibers, kenaf fibers, abaca fibers, hemp fibers and flax fibers or a combination thereof.

10. The hollow body according to claim 2, wherein at least one of the supporting layers and preferably all of the supporting layers comprise at least natural fibers and/or synthetic fibers, the mass ratio of natural fibers to synthetic fibers preferably being in the range from 1 to 2 to 2 to 1.

11. The hollow body according to claim 2, wherein at least one of the supporting layers has at least one carrier material and at least one wooden layer.

12. The hollow body according to claim 11, wherein the wooden layer has a thickness of at least 0.4 mm and at most 1.2 mm.

13. The hollow body according to claim 11, wherein the carrier material is a nonwoven.

14. The hollow body according to claim 1, wherein the matrix material comprises a resin.

15. The hollow body according to claim 1, wherein the main body has a circular, oval, rectangular or polygonal cross-section.

16. The hollow body according to claim 1, wherein the main body has a constant cross-section or a cross-section that tapers at least partially in the direction of at least one end of the main body.

17. The hollow body according to claim 1, wherein the main body has at least one connector which is suitable for engaging in at least one of the layers.

18. The hollow body according to claim 17, wherein the connector is incorporated into the sheet-like textile structure of at least one textile layer and/or one supporting layer.

19. The hollow body according to claim 1, further comprising staples connecting two or more layers.

20. The hollow body according to claim 1, comprising a decorative layer as the outermost layer.

21. The hollow body according to claim 1, wherein the main body has at least one additional textile layer and/or a supporting layer in sections along its longitudinal direction of extension.

22. A method for producing a multilayer main body for a hollow body according to claim 1, wherein the method comprises:
a) providing material webs for at least one textile layer comprising natural fibers selected from the group of bast fibers, leaf fibers and fruit fibers or a combination thereof;
b) spiral winding of at least one material web around a longitudinal axis of a winding mandrel to form a layer of the main body;
c) spiral winding of at least one material web to form a subsequent layer in an area in which a previous, adjacent layer has already been formed;
d) repeating step c) until all the layers of the main body to be wound have been formed, the layers comprising at least one textile layer;
e) curing of a liquid and/or liquefied matrix material introduced into at least one of the material webs in such a way that a solidified main body is formed.

23. The method according to claim 22, wherein at least one material web for a textile layer is pre-impregnated.

24. The method according to claim 22, wherein the material web of a subsequent layer is wound essentially at the same time and in the same area as the material web of a previous layer.

25. The method according to claim 22, wherein the material web of one layer is wound parallel to a joint.

26. The method according to claim 25, wherein the material web of a subsequent adjacent layer is wound in such a way that it covers a joint formed in the previous layer.

27. The method according to claim 22, wherein one or more connectors are provided on at least one material web or between a previous layer and a subsequent layer, for coupling at least two layers to one another before the matrix material cures.

28. The method according to claim 27, wherein an adhesive is applied at least partially to the material web of a subsequent layer before winding.

29. The method according to claim 27, wherein at least one of the one or more connectors is a thread coated with an adhesive, which is wound in sections between two layers and/or is incorporated into a sheet-like textile structure of one of the layers.

30. The method according to claim 27, wherein at least one of the one or more connectors comprises a metal strip which is configured to absorb shear forces occurring between two layers.

31. The method according to claim 27, wherein at least one of the one or more connectors comprises a clamp for connecting at least two adjacent layers.

32. The method according to claim 22, comprising covering the main body with a sheath layer serving to maintain a pressure built up in the main body by the web of material wound under a specific tensile stress, the sheath layer being detachable from the main body after the matrix material has cured.

33. The method according to claim 22, wherein an innermost layer of the main body comprises paper or cardboard and forms a counter-pressure body, and wherein the method comprises winding the innermost layer around the longitudinal axis of the winding mandrel before the remaining webs of material in such a way that the counter-pressure body is cured by the time the remaining webs of material are wound.

34. The method according to claim 22, wherein at least the outermost and/or the innermost layer of the main body is open to diffusion in such a way that gases produced during the method can escape from the main body.

35. The method according to claim 22, wherein the main body is wound in an endless process and is cut to a specific length after the matrix material has hardened.

36. The method according to claim 22, comprising dip-impregnating the main body with a matrix material and squeezing out excess matrix material from the layers.
